(19) United States
(12) Patent Application Publication
(10) Pub. No.: US 2018/0027359 A1
(43) Pub. Date: Jan. 25, 2018

(54) Integrated Street Light Controller and Small Cell

(71) Applicant: Petra Systems, Inc., South Plainfield, NJ (US)

(72) Inventors: Juan Jose Gonzalez, South Plainfield, NJ (US); Steve Rhoades, South Plainfield, NJ (US); Fernando G. Tomasel, South Plainfield, NJ (US)

(21) Appl. No.: 15/655,459

(22) Filed: Jul. 20, 2017

Related U.S. Application Data
(60) Provisional application No. 62/364,793, filed on Jul. 20, 2016.

(51) Int. Cl. H04W 4/00; H05B 37/02

(52) U.S. Cl. CPC H04W 4/005; H05B 37/0272; H04W 84/18

(57) ABSTRACT

A device comprising a light controller for monitoring and controlling a street light; an electrical connector for transmitting information between the light controller and the street light; and one or more transceivers configured for connecting the light controller to a network having connectivity to a carrier backhaul, and providing a wireless access point for connecting one or more user devices to the network. Systems and methods for remotely monitoring and controlling operation of a plurality of street lights, comprising a plurality of devices; a communications network established by one or more transceivers of the plurality of devices and providing connectivity between the plurality of devices and a carrier backhaul; and a remote station in communication with the carrier backhaul, the remote station configured to transmit and receive information for monitoring and controlling operation of the plurality of street lights using the plurality of devices.

### CROSS-REFERENCE TO RELATED APPLICATIONS

This application claims priority to U.S. Provisional Patent Application No. 62/364,793, filed Jul. 20, 2016, the entirety of which is hereby incorporated by reference for all purposes.

### BACKGROUND

Telecommunications providers face significant challenges in accommodating ever-increasing data consumption by consumers. Small cell networks have been suggested as a potential way to increase bandwidth; however, small cell networks face their own set of challenges. For example, it can be difficult to make small cell networks cost effective due to the costs of adding additional infrastructure and finding available real estate for said infrastructure in close enough proximity to users. Further, small cell networks face challenges in terms of gaining access to high-throughput backhaul solutions at connecting points, as well as in gaining access to electrical power at connecting points.

Accordingly, there is a need for solutions that provide additional bandwidth while offsetting the costs of purchasing, installing, and maintaining associated infrastructure, simplifying access to suitable real estate and infrastructure on which to deploy small cell systems, accessing high-throughput data pipelines, and providing electrical power to the small cell systems.

### SUMMARY

In one aspect, the present disclosure is directed to devices for deployment on a street light, the device comprising a light controller configured for monitoring and controlling an operation of the street light; an electrical connector for transmitting information regarding the operation of the street light between the light controller and the street light; and one or more transceivers configured for: connecting the light controller to a network, the network having connectivity to a point of connection to a carrier backhaul, and providing a wireless access point for connecting one or more user devices to the network.

The one or more transceivers for connecting the light controller to the network, in various embodiments, may be configured to transmit, from the light controller to the network, information concerning operation of the street light for monitoring at a remote location. The information concerning operation of the street light, in some embodiments, may include at least one of diagnostics, detected faults, and metering of electrical power consumption. Additionally or alternatively, the one or more transceivers for connecting the light controller to the network, in various embodiments, may be configured to transmit, from the network and to the light controller, information associated with controlling operation of the street light. The information concerning operation of the street light, in some embodiments, may include at least one of instructions for power on/off, dimming, time scheduling, and photocontrol settings.

In some embodiments, the one or more transceivers for connecting the light controller to the network may include a backhaul radio, and the one or more transceivers for providing a wireless access point to the network may include an access point radio. In some other embodiments, the one or more transceivers for connecting the light controller to the network may include a media converter, and the one or more transceivers for providing a wireless access point to the network may include an access point radio.

The electrical connector, in some embodiments, may be further configured for receiving electrical power from the street light for powering the device. The one or more user devices, in various embodiments, may include at least one of a cellular phone, a smart phone, a tablet, an autonomous vehicle, a non-autonomous vehicle, and a computer.

In another aspect, the present disclosure is directed to systems for deployment on a plurality of street lights, the system comprising a plurality of devices configured for deployment on a plurality of street lights, each comprising a light controller and one or more transceivers; a communications network established by the one or more transceivers of the plurality of devices and providing connectivity between the plurality of devices and a point of connection to a carrier backhaul; and a remote station in communication with the carrier backhaul, the remote station configured to transmit and receive information for monitoring and controlling operation of the plurality of street lights using the plurality of devices.

The one or more transceivers, in various embodiments, may include a backhaul radio for wirelessly connecting with at least one of the other plurality of devices via the communications network. The communications network, in some such embodiments, may include one of a wireless mesh network, a point-to-point network, or a point-to-multipoint network. In some embodiments, the one or more devices may be placed within approximately 30 meters of one another.

The one or more transceivers, in various embodiments, may additionally or alternatively include an access point radio for providing a wireless access point to the communications network through which one or more user devices may connect to the communications network. The one or more user devices, in various embodiments, may include at least one of a cellular phone, a smart phone, a tablet, an autonomous vehicle, a non-autonomous vehicle, and a computer.

In some embodiments aspect, the present disclosure is directed to methods for remotely monitoring and controlling operation of a plurality of street lights, the method comprising deploying a plurality of devices on a plurality of street lights, each of the plurality of devices comprising a light controller and one or more transceivers; establishing a communications network between the one or more transceivers of the plurality of devices; providing connectivity between the communications network and a point of connection to a carrier backhaul; and transmitting and receiving, between the plurality of devices and a remote monitoring station in communication with the carrier backhaul, information for monitoring and controlling operation of the plurality of street lights using the plurality of devices.

The one or more transceivers, in various embodiments, may include a backhaul radio for wirelessly connecting with at least one of the other plurality of devices via the communications network.

The one or more transceivers, in various embodiments, may additionally or alternatively include a media converter for providing connectivity between the communications network and the carrier backhaul.

The one or more transceivers, in various embodiments, may additionally or alternatively include an access point radio for providing a wireless access point to the communications network through which one or more user devices may connect to the communications network.

In still another aspect, the present disclosure is directed to another device for deployment on a street light, the device comprising a light controller configured for monitoring and controlling an operation of the street light; an electrical connector for transmitting information regarding the operation of the street light between the light controller and the street light; one of: a media converter configured for providing a direct connection between the light controller and a point of connection to a carrier backhaul, and a radio configured for connecting the light controller to a network, the network having connectivity to a point of connection to a carrier backhaul; and a radio configured for providing a wireless access point for connecting one or more user devices to the media converter or to the network.

### BRIEF DESCRIPTION OF THE DRAWINGS

The presently disclosed embodiments will be further explained with reference to the attached drawings, wherein like structures are referred to by like numerals throughout the several views. The drawings shown are not necessarily to scale, with emphasis instead generally being placed upon illustrating the principles of the presently disclosed embodiments.

FIG. 1 shows a perspective view of a device integrating street light control and small cell technology, in accordance with an embodiment of the present disclosure;

FIG. 2 shows side and bottom views of a device integrating street light control and small cell technology, in accordance with an embodiment of the present disclosure;

FIG. 3 is a schematic depiction of various modules of an integrated small cell street light control device, in accordance with an embodiment of the present disclosure;

FIG. 4 is a flow chart showing flow of electrical power amongst various components of an integrated small cell street light control device, in accordance with another embodiment of the present disclosure;

FIG. 5 schematically illustrates connectivity between a light controller and various sensors and utility modules, in accordance with another embodiment of the present disclosure;

FIG. 6 schematically illustrates network connectivity between components of an integrated small cell street light control device and a carrier backhaul, in accordance with another embodiment of the present disclosure;

FIG. 7A schematically depicts an integrated small cell street light control device, in accordance with an embodiment of the present disclosure;

FIG. 7B schematically depicts connectivity between the device of FIG. 7A and: (i) a user device and (ii) a point of connection to a carrier backhaul, in accordance with an embodiment of the present disclosure;

FIG. 8A schematically depicts an integrated small cell street light control device, in accordance with an embodiment of the present disclosure;

FIG. 8B schematically depicts connectivity between the device of FIG. 8A and: (i) a user device, (ii) a point of connection to a carrier backhaul, and (iii) a backhaul radio of the integrated small cell street light control device of FIG. 9B, in accordance with an embodiment of the present disclosure;

FIG. 9A schematically depicts an integrated small cell street light control device, in accordance with an embodiment of the present disclosure;

FIG. 9B schematically depicts connectivity between the device of FIG. 9A and: (i) a user device and (ii) a backhaul radio of the integrated small cell street light control device of FIG. 8B, in accordance with an embodiment of the present disclosure;

FIG. 10A, FIG. 10B, and FIG. 10C illustrate modular architectures of integrated small cell street light control devices having a single radio, a dual radio, and a dual radio with modem, respectively, in accordance with three embodiments of the present disclosure;

FIG. 11 is a schematic depiction of various small cell networks associated created by various integrated small cell street light control systems, in accordance with various embodiments of the present disclosure; and

FIG. 12A and FIG. 12B are schematic depictions of a point-to-multipoint wireless small cell network and a mesh wireless network created by various integrated small cell street light control systems, in accordance with embodiments of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

Embodiments of the present disclosure include devices and systems for providing remote monitoring and/or control of the street lights, as well as providing wireless network connectivity in densely-populated areas via small cell technology.

Embodiments of the present disclosure integrate technologies that leverage unique aspects of street light infrastructure to benefit utility companies, telecommunications carriers, the local community, and the environment alike. The ability offered by the devices and systems disclosed herein to monitor and control street light operation may reduce operating costs (e.g., use less electricity) and maintenance costs (e.g., via diagnostics and fault monitoring) for utility companies, while also allowing the utility companies (or other entity that owns the street lights) to generate revenue by helping telecommunications carriers offload traffic from their macro networks, amongst other benefits. Telecommunications carriers may benefit from deployment of the system by reaching more customers, providing increased coverage and capacity over competitors, reducing macro infrastructure costs, and reducing the cost and complexity of infrastructure licensing, as they could deal with a single landlord (e.g., the utility company) for multiple deployments, amongst other potential benefits. The local community may benefit from increased network capacity and coverage and reduced utility fees, amongst other potential benefits, and the environment may benefit from reduced energy consumption, light pollution, and vehicle pollution resulting from inefficient monitoring and maintenance rounds.

The integration of light control and small cell technologies into a street-light-mounted system may allow for deploying everything at once by a single actor, thereby greatly reducing the logistics and associated labor and cost of deploying such technologies piecemeal and via different actors. The modular nature of some embodiments of the technology may further allow for reduced manufacturing and inventory costs, and relatively easy upgrades to already-deployed infrastructure as well. It should be noted, however, that while the devices and systems of the present disclosure are described in connection with street lights to be mounted, for example, on existing street light poles, the present systems may be also be disposed on a different infrastructure, such as buildings, houses, towers, etc. In some embodiments, the present devices and systems include variations where, in addition to or alternatively to light controllers, small cells can be integrated with other systems which include a controller.

### Device 100

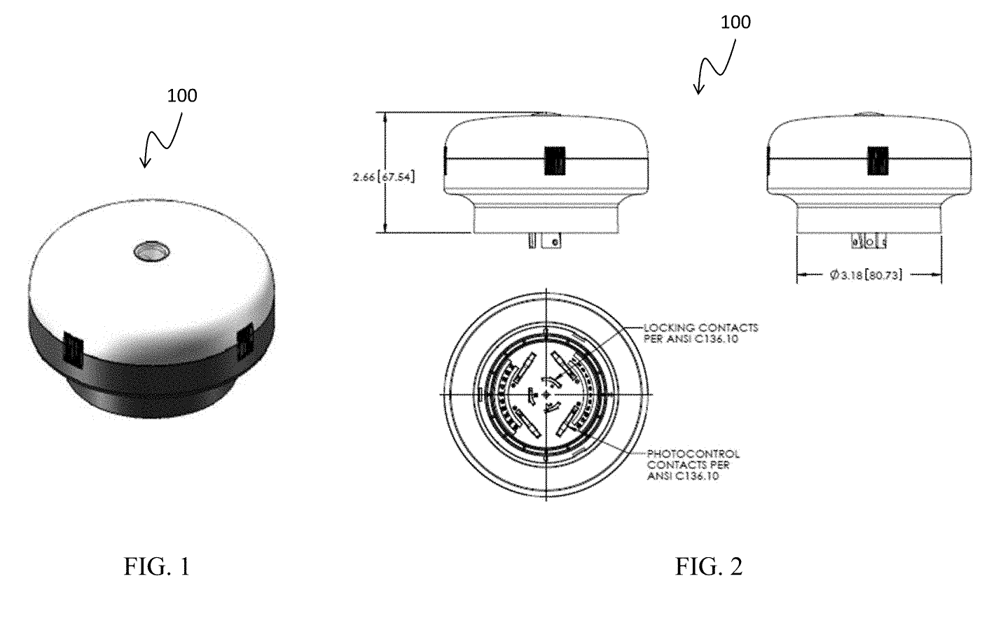

FIGS. 1 and 2 depict a representative embodiment of device 100 that integrates light control and small cell technologies in accordance with the present disclosure. Device 100, in various embodiments, may be physically mounted on a street light 110 luminaire or otherwise integrated as a part thereof. When configured as a standalone device to be coupled to a luminaire, the device, in some embodiments, may include an outdoor-rated housing for protection from the elements, as shown. This may not be necessary if the device is instead integrated within or otherwise built into the luminaire itself. One or more electrical connections between the device and the luminaire may further allow for the system to monitor and control features of the street light's 110 operation such as, without limitation, power on/off, dimming, time scheduling, photocontrol, revenue grade metering (RGM), fault detection, and diagnostics. The electrical connection(s) may further allow for the system to transmit and receive data, and to draw electrical power from the electrical grid, via the luminaire, for powering the system. In the representative embodiment shown, the system includes photocontrol contacts and locking contacts per the ANSI C136.10 Roadway and Area Lighting Equipment Standard such as those shown on the smart light controller of FIG. 1, allowing for easy twist-and-lock installation on luminaires having the corresponding receptacle. It should be recognized; however, that this is merely a representative embodiment, and one of ordinary skill in the art will recognize any number of electrical and/or physical coupling connections suitable for the stated purposes. For example, in some embodiments, the system may utilize wiring or other suitable electrical connections (e.g., a NEMA, 7-, 5-, or 3-pin connector) for electrically interfacing with the luminaire.

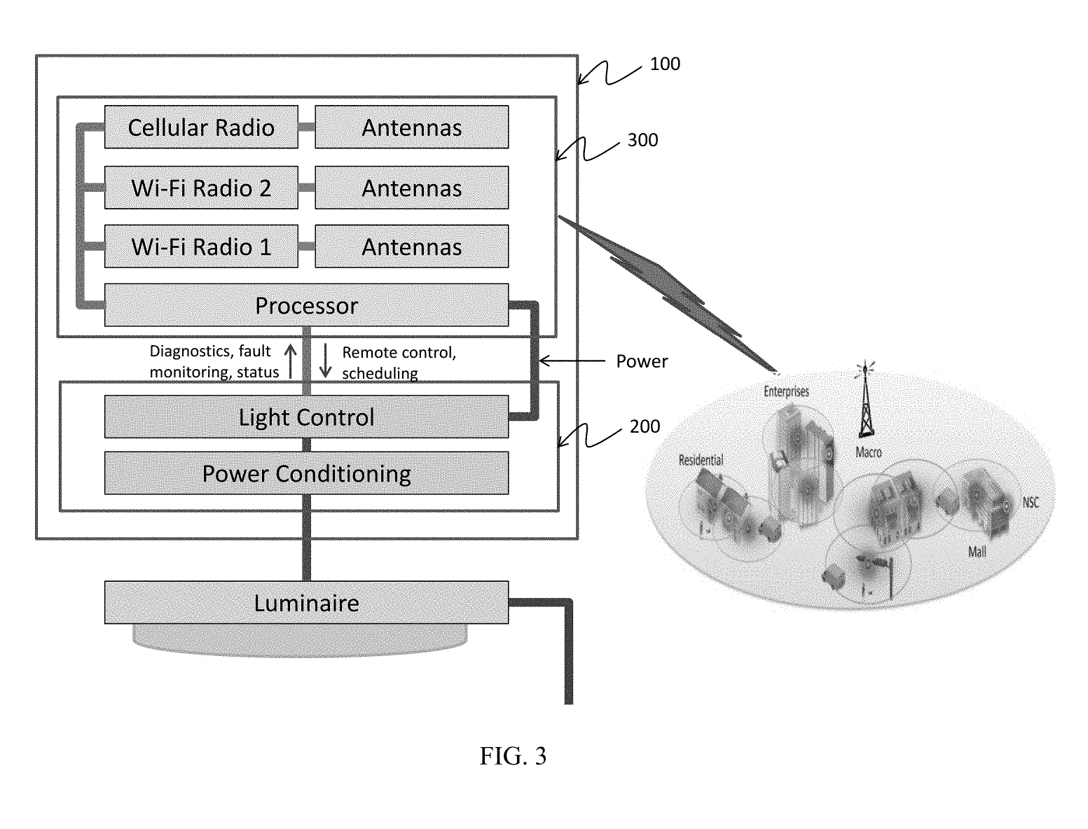

FIG. 3 is a schematic depiction showing various modules of device 100. In various embodiments, device 100 may generally comprise a light module 200 for interfacing with a street light 110 on which system 100 is mounted, and a small cell module 300 for generating a small cell network with access points for light module 200 and user equipment (e.g., smart phones, tablets, computers, autonomous and non-autonomous vehicles like drones). As configured, device 100 can provide connectivity between the access points and the backhaul of a traditional provider network, as later described in more detail.

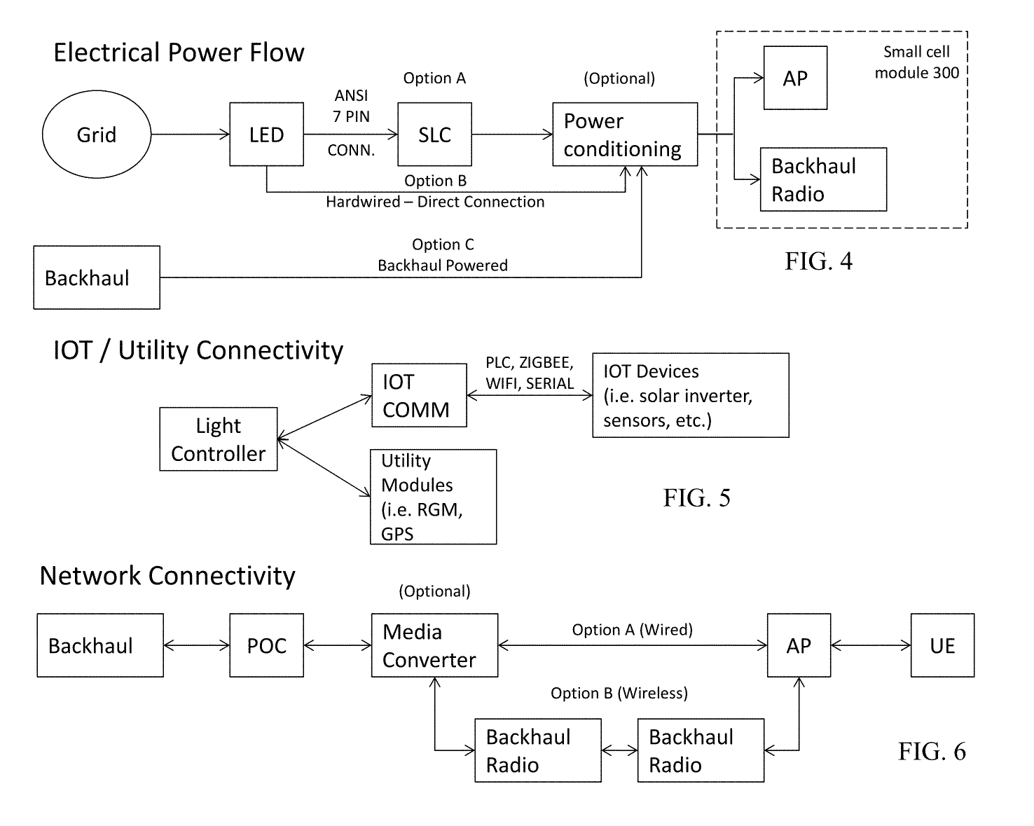

Connections within device 100, in various embodiments, may be configured for sharing power and/or data between various components. For example, as shown in FIG. 3 and depicted with red lines, device 100 may be configured to draw and condition electrical power from the street light 110 for powering various components of light module 200 and small cell module 300, as further described in more detail with respect to FIG. 4. Further, as shown in FIG. 3 and depicted with blue lines, connections may be provided between light module 200 and small cell module 300 along which data may be shared. For example, in some embodiments, light module 200 may transmit information to small cell module 300 for use in monitoring operation of the street light 110, such as diagnostics information, fault information, and status. Similarly, small cell module 300, in some embodiments, may transmit information to light module 200 for use in controlling operation of the street light 110, such as operational commands (e.g., turn on/off, dim) and scheduling commands.

### Light Control Module 200

Embodiments of light control module 200 of the present disclosure may generally comprise a light controller 210 for interfacing with and controlling operations of the street light 110, and a power conditioner 220 for conditioning electrical power from the street light 110 for use in powering device 100, as further described in more detail below.

Light controller 210 may include suitable hardware for monitoring and controlling operation of the luminaire. Generally speaking, light controller 210 may contain hardware and sensors suitable for performing the monitoring and control functionality described in the present disclosure. For example, light controller 210 may contain photosensors/photocontrollers used to perform on/off and dimming functions, energy measuring electronics and software to measure energy consumption and savings, communications electronics and software to communicate via PLC or other protocols with other devices (such as solar inverters and other Internet-of-Things (IoT) devices) to perform monitoring and control, processors and memory to store and execute control software, analog and digital interfaces to control functionality of the luminaires, etc. Light controller 210, in some embodiments (not shown), may include its own processor for performing monitoring and/or control functions. In other embodiments (as shown), light controller 210 may share a processor with the small cell module 300.

Referring now to FIGS. 3 and 4, power conditioner 220 may be configured to receive and condition electrical power from the street light 110 in a manner suitable for use by the components of light module 200 and/or small cell module 300, as shown. In particular, with reference to FIG. 4, power may originate from the electrical grid, where it is provided to the street light 110 for operating the luminaire and other associated systems. Device 100 may draw power from the street light 110, for example, through an ANSI 7-pin electrical connector connecting device 100 and the street light 110. Power conditioner 220 may receive this power and condition it for use by various components of device 100. In some embodiments, power conditioner 220 may direct conditioned power to light controller 210 which, in turn, may provide conditioned electrical power to components of small cell module 300, such as processor 310, radio(s) 320, and antenna(s) 330 (if powered), as shown in Option A. In another embodiment, power conditioner 220 may direct conditioned power directly to small cell module 300 rather than first routing this conditioned power through light controller 210, as shown in Option B. In some embodiments embodiment, power may originate from the backhaul infrastructure (e.g., coaxial cable or Power over Ethernet (POE)), and is directed to components of small cell module 300, as shown in Option C.

In some embodiments, the device connects to the luminary by means of an electrical connector such as a NEMA 7, 5 or 3 pin connector, while in other embodiments, the device may be hardwired to the luminary. In some embodiments, the device is installed inside of the luminary.

Referring now to FIG. 5, light controller 210 may be further configured to interface with additional devices in the street light 110. In one such embodiment, light controller 210 may be in communication with one or more sensors configured for controlling and monitoring various operational aspects of the street light 110, such as light intensity, energy consumption, and device health. In another embodiment, light controller 210 may be in communication with an inverter configured to deliver power from an energy generation device (e.g., solar panel, wind turbine) mounted on the street light 110 to the electrical grid. As configured, light controller 210 can, additionally or alternatively, monitor operation of the energy generation device and/or the associated inverter. In some embodiments, the sensors and/or the inverter may be configured for Internet-of-Things connectivity with the light controller. In some embodiments embodiment, light controller 210 may be in communication with one or more utility modules associated with the street light 110, such as a Revenue Grade Meter (RGM) or Global Positioning Satellite (GPS) system. As configured, light controller 210 may provide for monitoring power consumption/generation and a location of the particular device 100.

### Small Cell Module 300

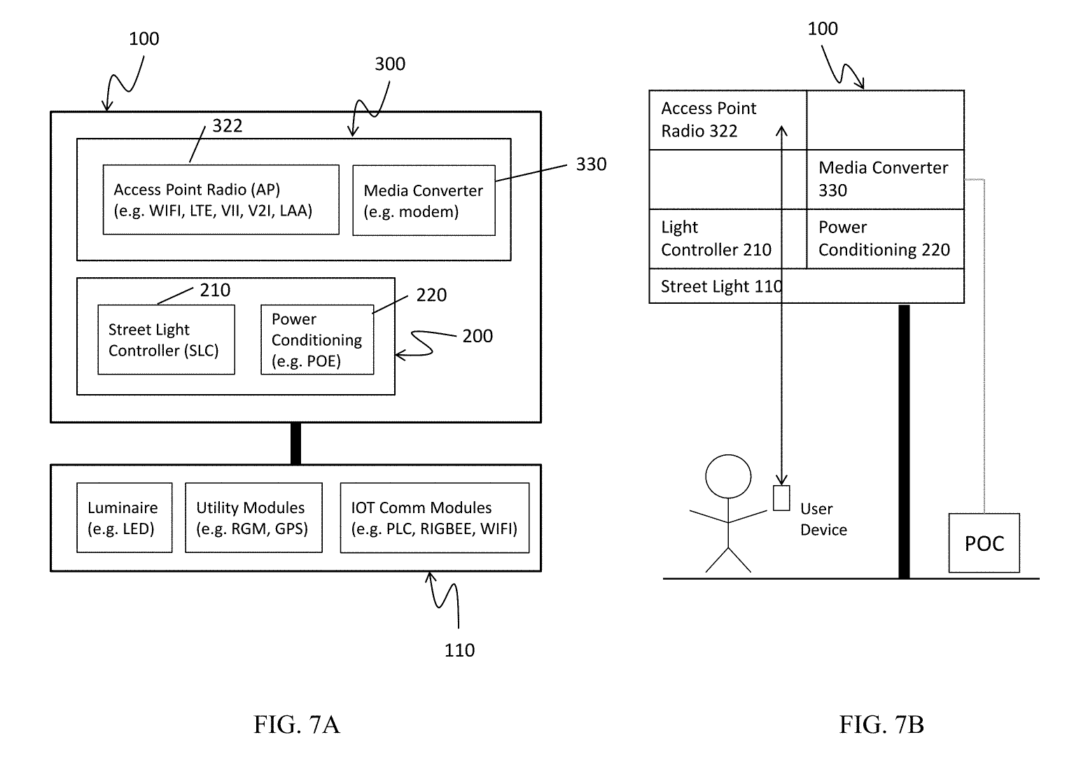

Referring now to FIGS. 7A-7B, 8A-8B, and 9A-9B, embodiments of small cell module 300 of the present disclosure may generally comprise a processor 310 for processing information and directing operation of small cell module 300, one or more radios 320 for providing an access point(s) to the small cell network (e.g., access point radio(s) 322) and/or for connecting with a radio(s) 320 of other devices 100 (e.g., backhaul radio(s) 324), one or more antennas 326 associated with the radio(s) 320, and a media converter 330 (e.g., modem, fiber media converter, etc.) for direct connectivity with the carrier backhaul, as further described in more detail below. Radio(s) 320 and media converter 330 may be collectively referred to as transceivers in the present disclosure.

Device 100, in various embodiments, may utilize small cell module 300 as a transceiver for communication with a remotely-situated monitoring and control station. In particular, in the embodiment shown, small cell module 300 may receive, from the light module 200, information associated with monitoring operation of the street light 110 (e.g., diagnostics, fault monitoring, and status information). Processor 310 may direct radio(s) 320 (and in particular, backhaul radio(s) 324) to transmit said information through the small cell network and ultimately to a monitoring and control station. Similarly, small cell module 300 may receive, via the small cell network, commands from a remote monitoring and control station for controlling and scheduling operation of the street light 110, as shown. In another embodiment (not shown), the system may instead include and utilize dedicated communications technology for remote monitoring and control (e.g., radios not utilized for small cell communication).

Additionally or alternatively, device 100, in various embodiments, may utilize small cell module 300 as a transceiver for connecting with nearby user equipment (e.g., cellular phones, smart phones, tablets, computers of nearby persons, nearby autonomous and non-autonomous vehicles like drones) and backhauling that traffic to/from main carrier networks via the small cell network. In particular, these small cell networks may be configured to provide any one or combination of local wireless data and cellular connectivity to user equipment situated nearby, such as cellular phones, smart phones, tablets, computers, nearby autonomous and non-autonomous vehicles like drones, and other devices requiring network connectivity. Establishing a local network over a small geographic area and backhauling these networks to the carrier network may serve to offload macro-level infrastructure (e.g., cellular towers) of corresponding traffic, thereby increasing spectrum capacity.

To this end, the small cell electronics may include any number and combination of radio types. In the representative embodiment shown, it may include, for example, a first Wi-Fi radio 322 (“Wi-Fi Radio 1) configured at 2.4 GHz for providing connectivity to nearby user equipment. A second Wi-Fi radio 324 (“Wi-Fi Radio 2) may be configured, for example, at 5 GHz and act as a backhaul between the local Wi-Fi network established by Wi-Fi Radio 1 and a carrier network. In some embodiments, the functionality of these two Wi-Fi radios may be combined into one Wi-Fi radio, as would be understood by one of ordinary skill of the art. Additionally or alternatively, one or more cellular radios (e.g., 3G, 4G) may be provided for establishing local cellular networks and/or serving as backhauls. Any one or combination of the radios 320 utilized, in various embodiments, may operate on licensed and/or unlicensed spectrums and on single or multiple frequency bands. The network may optionally use self-organizing network technologies to avoid interference between radios 320 and maximize the coverage and capacity of the network. The radio(s) 320 and antenna(s) 326, in various embodiments, may be integrated within, or mounted on and wired to, the system.

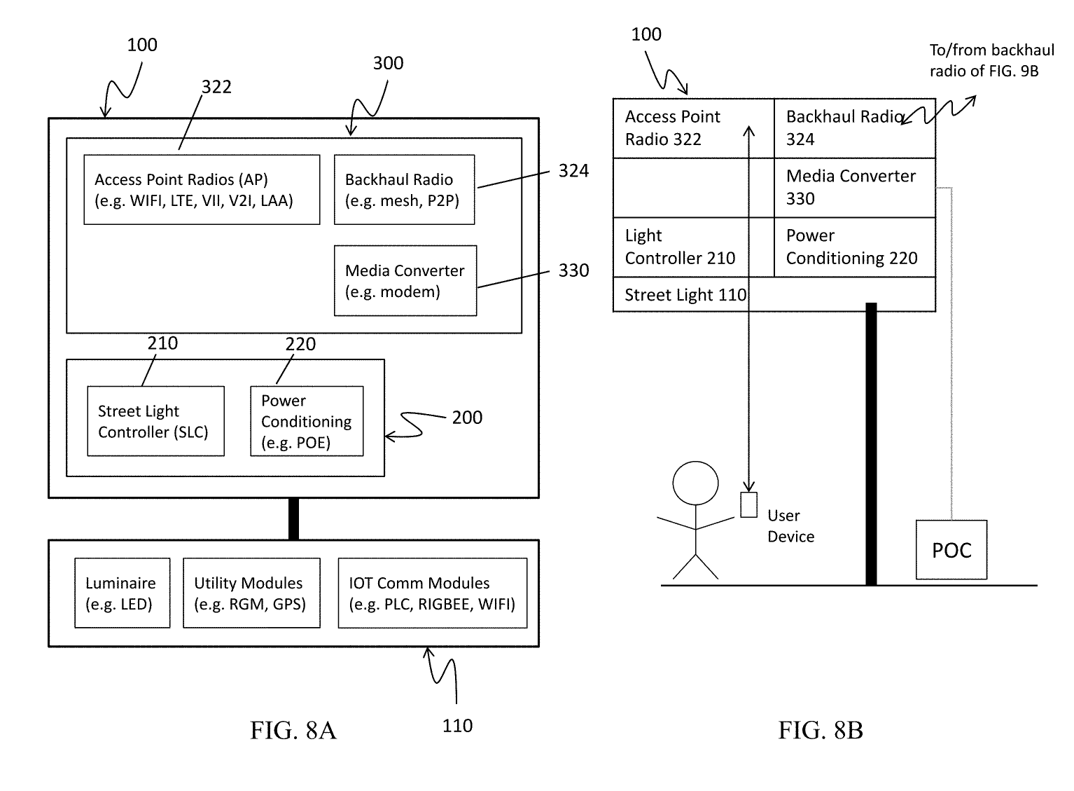

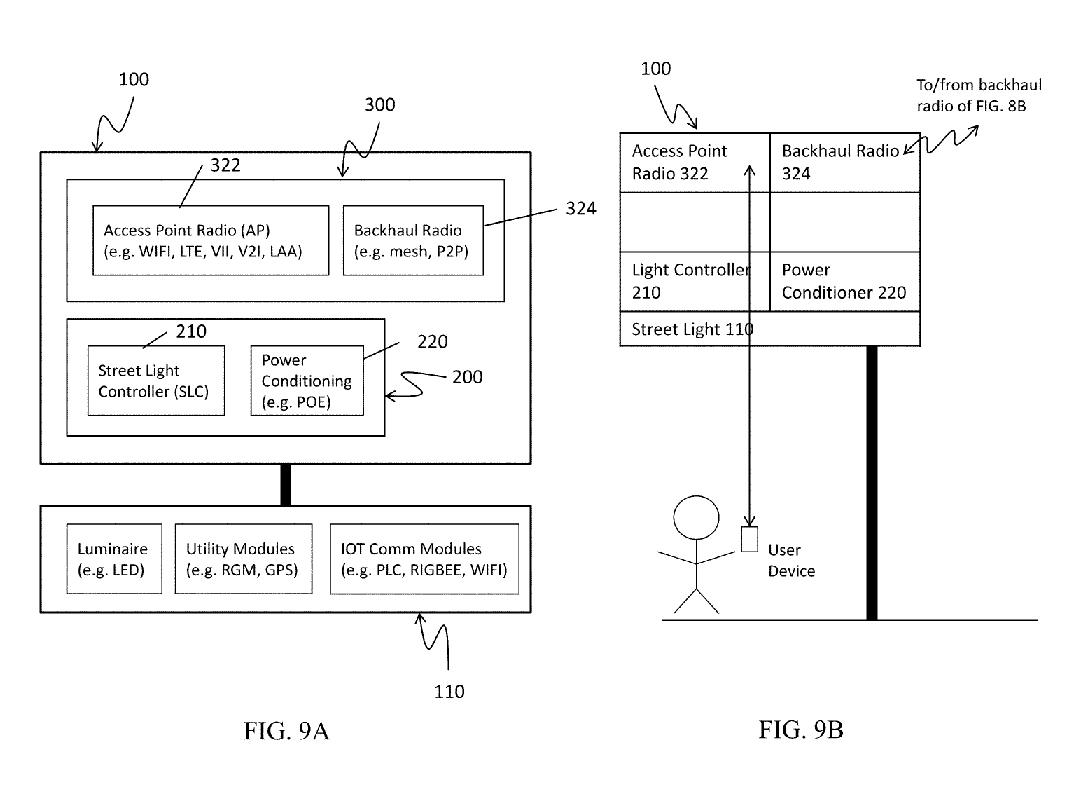

In some embodiments, the radio(s) 320 may support Wi-Fi and/or 3G/4G operation (operating on a single or multiple frequency bands, on licensed or unlicensed spectrum). In some embodiments, backhaul connectivity is provided by a wired connection (e.g., copper or fiber), as shown in FIGS. 7A and 7B, and later described in more detail. In some embodiments, backhaul connectivity is provided wirelessly by backhaul radio(s) 324 by a mesh, point-to-point, and/or point-to-multipoint network operating on a single or multiple frequency bands on licensed or unlicensed spectrum, as shown in FIGS. 8A-8B and 9A-9B, and later described in more detail. In some embodiments, the radio(s) and/or antenna(s) are integrated within the device, as further described below, while in other embodiments, the radio(s) and/or antenna(s) are mounted external to the device and wired into the device. In some embodiments, the device has internal and external antennas.

Components of small cell module 300 may be provided in any suitable configuration such as, without limitation, as system-on-chip, an integrated circuit, a chip set, a system in package, package on package or in any other arrangement suitable for providing power and electronic communication between respective components in accordance with the functionality described herein.

FIGS. 7A-7B, 8A-8B, and 9A-9B provide schematic illustrations of various embodiments of device 100. Primary differences between these three embodiments generally center around variations in small cell module 300 depending on whether that particular embodiment is configured to connect directly to a backhaul point of connection (POC), or to indirectly connect thereto via the small cell network, as further described in more detail below.

Referring now to FIGS. 7A and 7B, illustrated is a representative embodiment of device 100 configured for connecting directly to a point of connection of the carrier backhaul. In particular, as shown in FIG. 7A, small cell module 300 of this embodiment may include an access point radio(s) 322 for connecting with nearby user equipment, and a media converter 330 (e.g., modem, fiber media converter, etc.) for connecting to the carrier backhaul (e.g., coax or fiber utilities owned/maintained by a provider such as Comcast). As configured, the user equipment connects to an access point provided by access point radio 322, and media converter 330 connects the access point to the provider backhaul, thereby connecting the user equipment and provider network as shown in FIG. 7B.

Referring now to FIGS. 8A and 8B, illustrated is a representative embodiment of device 100 configured for: (i) directly connecting its access point(s) directly to the carrier backhaul, and (ii) indirectly, via the small cell network, connecting access points of other devices 100 to a point of connection of the carrier backhaul. In particular, as shown in FIG. 8A, small cell module 300 of this embodiment may include an access point radio(s) 322 and a media converter 330 (e.g., modem, fiber media converter, etc.) as in the embodiment of FIG. 7A, and additionally a backhaul radio(s) 324 for connecting with a backhaul radio(s) 324 of other devices 100. As configured, device 100 of the present embodiment may directly connect nearby user equipment (and/or light controller 210) to the carrier backhaul (technically, through an intermediate access point provided by access point radio 322), and indirectly connect user equipment (and/or light controller 210) associated with other devices 100 to the provider backhaul, via a connection between backhaul radio(s) 324 of the present device 100 and backhaul radio(s) 324 of the other devices 100, as shown in FIG. 8B. Note that in both FIGS. 7 and 8 the media converter may be integrated instead into the point of connection to the backhaul, in which case the connection between device 100 and the POC can be done by either wired or wireless means.

Referring now to FIGS. 9A and 9B, illustrated is a representative embodiment of device 100 configured for indirectly connecting nearby user equipment with a provider backhaul via intermediate connection(s) with other devices 100. In particular, as shown in FIG. 9A, the present embodiment lacks a media converter 330 for directly connecting to a point of connection of the provider backhaul, and instead includes an access point radio(s) 322 and a backhaul radio(s) 324. As configured, nearby user equipment connects to an access point provided by access point radio 322, and backhaul radio(s) 324 connects the access point to a backhaul radio(s) 324 of another device(s) 100, as shown in FIG. 9B. In some cases, the present device 100 may only need to make one hop to reach a device 100 like that of FIGS. 8A and 8B; in other cases, multiple hops through several devices 100 of the present embodiment may be needed until a POC-connected device 100 is reached.

### Component Integration

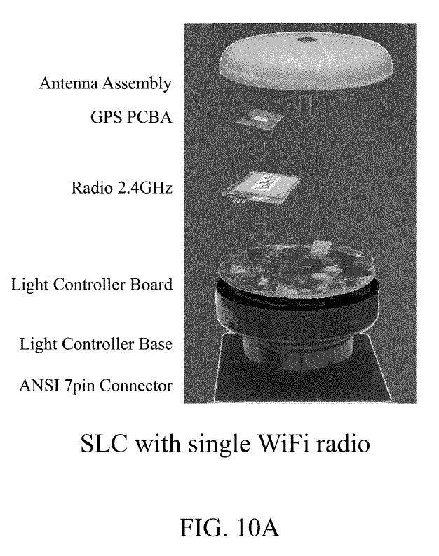

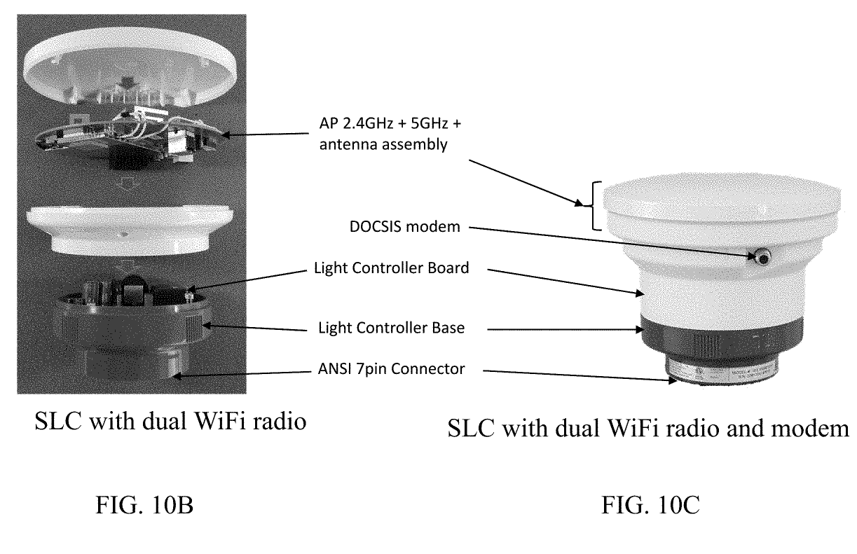

Device 100, in various embodiments, may have a modular architecture. In a representative embodiment, components of light module 200 (e.g., light controller 210 and power conditioner 220) may be packaged or otherwise physically grouped together, and components of small cell module 300 (e.g., processor 310, radio(s) 320, antenna(s) 326, and/or media converter 330) may be packaged or otherwise physically grouped together. Connections may then be provided for electrical power and data flow between the modules. Such a modular approach may allow for easily connecting, for example, the small cell electronics to already-deployed light control hardware. A representative example of such modular architecture is later explained in more detail with reference to FIGS. 10A-10C. Of course, in other embodiments, these components may be packaged within the system in any arrangement suitable for the stated functional purposes.

Referring now to FIGS. 10A-10C, in a representative embodiment, components of light module 200 may be arranged on an integrated circuit board (“light controller board”). The light controller board may then be coupled onto a light controller base member configured with an electrical connector (e.g., ANSI 7 pin connector) to the street light 110. As shown in FIG. 10A, in some embodiments, the light controller board may be configured to receive components of small cell module 300, such as a single wi-fi radio 320 (e.g., access point radio 322) and an associated printed circuit board assembly (PCBA). An antenna assembly may be coupled with or built into a top portion of the housing, which may then be joined with the light controller base member, completing the modular assembly. In another representative embodiment, as shown in FIG. 10B, a dual wi-fi radio (e.g., 2.4 GHz for access point and 5 GHz for backhaul) and antenna assembly may be arranged on a second integrated circuit board, which in turn may be connected to the first integrated circuit board containing components of light module 200. In some embodiments representative embodiment, a DOCSIS modem (media converter) may additionally be included in the embodiment described in connection with FIG. 10C.

The compact packaging afforded by the present architecture may shipment and installation, and may further allow for device 100 to be small and aesthetically-pleasing in profile, which can be an important factor in social adoption by local residents.

### System 500

The present disclosure is further directed to a system 500 including a plurality of the devices 100, which may be densely deployed on existing infrastructure (e.g., street lights 110) in an urban environment to create a continuous blanket of coverage. In various embodiments, one or more of the devices 100 may directly connect to a POC of a carrier backhaul (as shown and described in connection with FIGS. 7A-7B and 8A-8B), and in some embodiments, may serve to indirectly connect access points of other devices 100 (such as those of FIGS. 9A-9B) to the POC (as shown and described in connection with FIGS. 8A-8B).

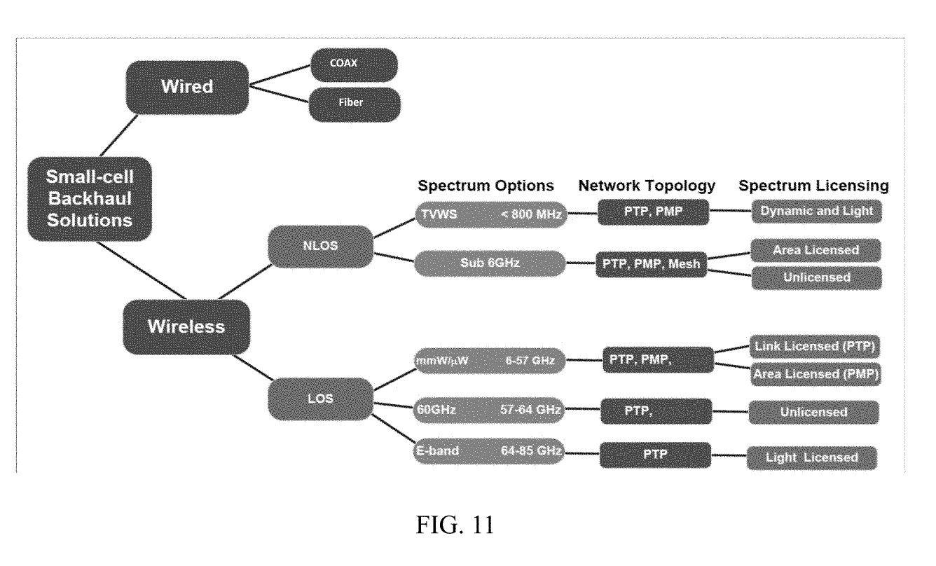

FIG. 11 a schematic depiction of various representative examples of small cell networks that may be created by various embodiments of system 500. Multiple devices 100 may connect to one another in any suitable manner for forming a small cell network capable of backhauling traffic to a carrier network (typically operated by telecommunications companies), including via wired infrastructure, wireless signals, or a combination of both. In one embodiment, multiple devices 100 may establish a wireless mesh network with one another (using backhaul radios 324), forming a mesh backhaul to an access point, such as a gateway. Such an approach may be especially well-suited to the street-light-mounted system 500 disclosed herein, as street lights 110 tend to be spaced apart at distances (e.g., ˜30 m) short enough to place the systems within range of one another for small cell communications. Of course, in situations where two or more of the devices 100 need to be spread out from one another beyond the effective range of their backhaul radios 324, an intermediate radio(s) 324 may be deployed between these devices 100 to bridge the gap. In another embodiment, multiple devices 100 may connect to one another by creating a point-to-point network between backhaul radios 324. In some embodiments embodiment, multiple devices 100 may connect to one another by creating a point-to-multipoint network between backhaul radios 324. Self-organizing network technologies may be used in suitable embodiments to avoid interference between backhaul radios 324 and to maximize the coverage and capacity of the small cell network. In some embodiments embodiment, one or more of the devices 100 may instead connect to one another via wired connection (e.g., copper wire or fiber) for backhaul rather than via wireless radio, as shown in FIG. 11.

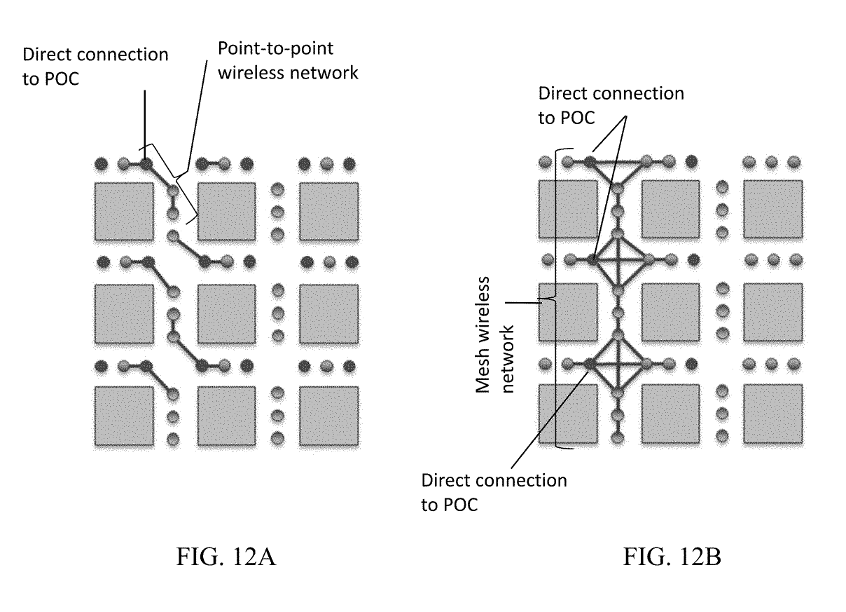

FIGS. 12A and 12B schematically depict representative embodiments of systems 500 deployed on the street lights 110 lining city blocks. Red dots in both figures represent direct connections to a POC of the carrier backhaul (e.g., cable modem to COAX or fiber connection). Blue dots in FIG. 12A represent a point-to-multipoint wireless small cell network (e.g., 5 GHz or DFS bands) for backhauling to a POC, and blue dots in FIG. 12B represent a mesh wireless small cell network for backhauling to a POC.

While the presently disclosed embodiments have been described with reference to certain embodiments thereof, it should be understood by those skilled in the art that various changes may be made and equivalents may be substituted without departing from the true spirit and scope of the presently disclosed embodiments. In addition, many modifications may be made to adapt to a particular situation, indication, material and composition of matter, process step or steps, without departing from the spirit and scope of the present presently disclosed embodiments. All such modifications are intended to be within the scope of the claims appended hereto.

What is claimed is:

1. A device for deployment on a street light, the device comprising:
a light controller configured for monitoring and controlling an operation of the street light;
an electrical connector for transmitting information regarding the operation of the street light between the light controller and the street light; and
one or more transceivers configured for:
connecting the light controller to a network, the network having connectivity to a point of connection to a carrier backhaul, and
providing a wireless access point for connecting one or more user devices to the network.

2. The device according to claim 1,
wherein the one or more transceivers connecting the light controller to the network are configured to transmit, from the light controller to the network, information concerning operation of the street light for monitoring at a remote location.

3. The device according to claim 2,
wherein the information concerning operation of the street light includes at least one of diagnostics, detected faults, and metering of electrical power consumption.

4. The device according to claim 1,
wherein the one or more transceivers connecting the light controller to the network are configured to transmit, from the network and to the light controller, information associated with controlling operation of the street light.

5. The device according to claim 4,
wherein the information associated with controlling operation of the street light includes at least one of instructions for power on/off, dimming, time scheduling, and photocontrol settings.

6. The device according to claim 1,
wherein the one or more transceivers configured for connecting the light controller to a network includes a backhaul radio, and
wherein the one or more transceivers configured for providing a wireless access point to the network includes an access point radio.

7. The device according to claim 1,
wherein the one or more transceivers configured for connecting the light controller to a network includes media converter, and
wherein the one or more transceivers configured for providing a wireless access point to the network includes an access point radio.

8. The device according to claim 1,
wherein the electrical connector is further configured for receiving electrical power from the street light for powering the device.

9. The device according to claim 1,
wherein the one or more user devices include at least one of a cellular phone, a smart phone, a tablet, an autonomous vehicle, a non-autonomous vehicle, and a computer.

10. A system for deployment on a plurality of street lights, the system comprising:
a plurality of devices configured for deployment on a plurality of street lights, each comprising a light controller and one or more transceivers;
a communications network established by the one or more transceivers of the plurality of devices and providing connectivity between the plurality of devices and a point of connection to a carrier backhaul; and
a remote station in communication with the carrier backhaul, the remote station configured to transmit and receive information for monitoring and controlling operation of the plurality of street lights using the plurality of devices.

11. The system according to claim 10,
wherein the one or more transceivers of at least one of the plurality of devices includes a backhaul radio for wirelessly connecting with at least one of the other plurality of devices via the communications network.

12. The system according to claim 11,
wherein the communications network is one of a wireless mesh network, a point-to-point network, or a point-to-multipoint network.

13. The system according to claim 12,
wherein the one or more devices are placed within approximately 30 meters of one another.

14. The system according to claim 10,
wherein the one or more transceivers of at least one of the plurality of devices includes a media converter for providing connectivity between the communications network and the carrier backhaul.

15. The system according to claim 10,
wherein the one or more transceivers includes an access point radio for providing a wireless access point to the communications network through which one or more user devices may connect to the communications network.

16. The system according to claim 15,
wherein the one or more user devices include at least one of a cellular phone, a smart phone, a tablet, an autonomous vehicle, a non-autonomous vehicle, and a computer.

17. A method for remotely monitoring and controlling operation of a plurality of street lights, the method comprising:
deploying a plurality of devices on a plurality of street lights, each of the plurality of devices comprising a light controller and one or more transceivers;
establishing a communications network between the one or more transceivers of the plurality of devices;
providing connectivity between the communications network and a point of connection to a carrier backhaul; and
transmitting and receiving, between the plurality of devices and a remote monitoring station in communication with the carrier backhaul, information for monitoring and controlling operation of the plurality of street lights using the plurality of devices.

18. The system according to claim 17,
wherein the one or more transceivers of at least one of the plurality of devices includes a backhaul radio for wirelessly connecting with at least one of the other plurality of devices via the communications network.

19. The system according to claim 17,
wherein the one or more transceivers of at least one of the plurality of devices includes a media converter for providing connectivity between the communications network and the carrier backhaul.

20. The system according to claim 17,
wherein at least one of the one or more transceivers includes an access point radio for providing a wireless access point to the communications network through which one or more user devices may connect to the communications network.

21. A device for deployment on a street light, the device comprising:
a light controller configured for monitoring and controlling an operation of the street light;
an electrical connector for transmitting information regarding the operation of the street light between the light controller and the street light;
one of:
a media converter configured for providing a direct connection between the light controller and a point of connection to a carrier backhaul, and
a radio configured for connecting the light controller to a network, the network having connectivity to a point of connection to a carrier backhaul; and
a radio configured for providing a wireless access point for connecting one or more user devices to the media converter or to the network.
